(19) United States
(12) Patent Application Publication
(10) Pub. No.: US 2017/0185258 A1
(43) Pub. Date: Jun. 29, 2017

(54) Use rotate gesture to quickly scroll and select in place

(71) Applicant: Dan Fu, Sunnyvale, CA (US)

(72) Inventor: Dan Fu, Sunnyvale, CA (US)

(73) Assignee: Vimo Labs Inc., Mountain View, CA (US)

(21) Appl. No.: 14/981,277

(22) Filed: Dec. 28, 2015

(51) Int. Cl. G06F 3/0488; G06F 3/0485; G06F 3/0482

(52) U.S. Cl. CPC G06F 3/0488; G06F 3/0482; G06F 3/0485

(57) ABSTRACT

The present disclosure describes a method to select an item from a list of items. Upon user touching the selectable item, a new selection interface is shown, including a scroll list of a subset of the selectable items, and an indicator that the user can rotate to select. User uses a rotate gesture to scroll backward and forward through the list, and upon user releasing the touch, the center item is selected.

### CROSS-REFERENCE TO RELATED APPLICATIONS

NOT APPLICABLE

### FEDERALLY SPONSORED RESEARCH

NOT APPLICABLE

### SEQUENCE LISTING OR PROGRAM

NOT APPLICABLE

### BACKGROUND OF THE INVENTION

Field

This disclosure concerns a system and method allowing a person to use a rotate gesture on a multi-touch device to scroll through a list of items and select one item quickly.

Prior Art

Smart phones and smart watches have a smaller screen, which makes it hard to browse and select an item from a large repository of items. On smart phones, a popular pattern is to use a scrollable table to display the list of items. When a user wants to select an item from the list of items, she scrolls through the list with her finger on the screen up and down. When her finger reaches the end of the screen, she must lift her finger off the screen, move it to the other side of the screen, and start the scrolling motion again. The whole motion of lifting hand followed by moving hand slows down the scrolling. This is worse on a smaller screen, such as on smart watches, where many more hand movements are needed to scroll through the same list.

A rotating gesture is much easier to use on a smaller screen or in a smaller touch space, as the finger does not have to leave the screen. For example, the original iPod from Apple uses a click wheel, which allows a user to scroll through a list with her thumb using a rotating gesture. Recently, new smart watches introduce new mechanism to ease the scrolling. For example, Apple Watch has a digital crown on the side of the watch. User can turn the digital crown in a continuous motion to scroll through a list. Similarly, Samsung Gear S2 has a rotating dial on the top of the watch face. User can turn the dial to scroll. A drawback of these prior art is that they all require specialized hardware, which increases the cost and implementation complexity.

### SUMMARY OF THE INVENTION

The present invention includes a number of elements, which together overcome the limitation present in prior arts. In one aspect, the user uses the multi-touch screen that is present on all smart phones and smart watches. No extra hardware is required. User uses a rotating gesture on a multi-touch screen to scroll through a list, and when the user releases her finger, the item in the center is automatically selected.

In one aspect of the present invention, a user interface is shown on a smart phone or a smart watch. The user interface displays an item, which is one of a list of items. When the user places her hand on the item, a new selection interface is shown, which includes a scroll list of a subset of the selectable items and an indicator to show the user that she can use a rotating gesture. While the user rotates her finger forward, the list advances forward. While the user rotates her finger backward, the list moves backward. When the user stops rotating and lifts her finger, the item at the center of the scroll list is chosen.

### BRIEF DESCRIPTION OF THE DRAWINGS

The disclosure can be better understood with reference to the following drawings and description. The components in the figures are not necessarily to scale, emphasis instead being placed upon illustrating the principles of the invention. Moreover, in the figures, like referenced numerals designate corresponding parts or elements throughout the different views.

FIG. 1 shows, in prior art, how a user would select a new item by presenting a new screen and asking user to scroll in a non-rotating gesture.

FIG. 2 illustrates how a user would select in the present invention, by showing user a selection interface upon detecting a touch gesture and changing the list of items when user starts to rotate.

FIG. 3 illustrates the many different potential paths of a rotate gesture.

FIG. 4 shows a different embodiment of the present invention to select one menu option from several menu choices.

FIG. 5 is a flow diagram showing the steps of the present invention

FIG. 6 shows a block diagram of an apparatus configured to practice the present invention.

### DETAILED DESCRIPTION

Reference will now be made in detail to the preferred embodiments of the claimed subject matter, a method of capturing sports action with a smart watch, examples of which are illustrated in the accompanying drawings. While the claimed subject matter will be described in conjunction with the preferred embodiments, it will be understood that they are not intended to be limit to these embodiments. On the contrary, the claimed subject matter is intended to cover alternatives, modifications and equivalents, which may be included within the spirit and scope as defined by the appended claims.

Furthermore, in the following detailed descriptions of embodiments of the claimed subject matter, numerous specific details are set forth in order to provide a thorough understanding of the claimed subject matter. However, it will be recognized by one of ordinary skill in the art that the claimed subject matter may be practiced without these specific details. In other instances, well known methods, procedures, components, and circuits have not been described in detail as not to unnecessarily obscure aspects of the claimed subject matter.

Some portions of the detailed descriptions which follow are presented in terms of procedures, steps, logic blocks, processing, and other symbolic representations of operations on data bits that can be performed on computer memory. These descriptions and representations are the means used by those skilled in the art to most effectively convey the substance of their work to others skilled in the art. A procedure, computer generated step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present claimed subject matter, discussions utilizing terms such as “storing,” “creating,” “protecting,” “receiving,” “encrypting,” “decrypting,” “destroying,” or the like, refer to the action and processes of a computer system or integrated circuit, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices.

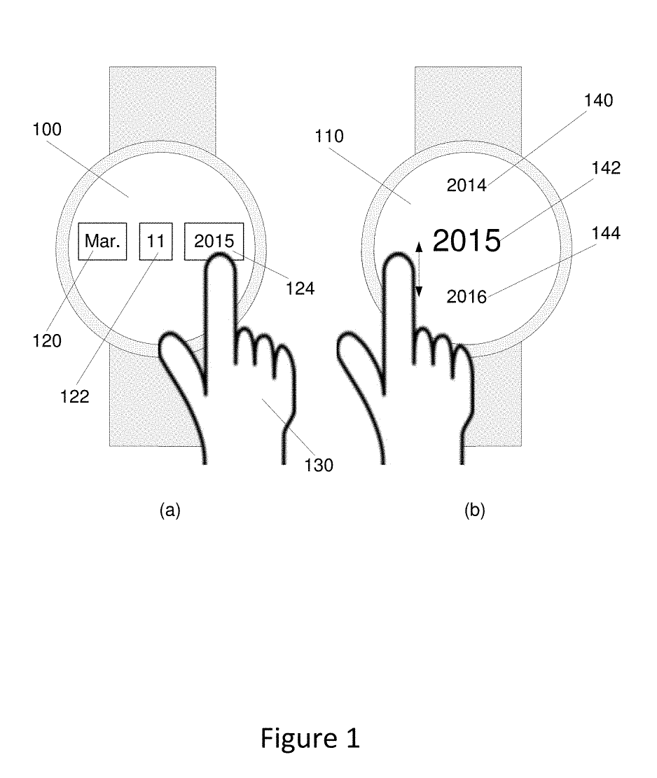

User often has to select an item from a long list of items on smart phones or smart watches. It is challenging on smart watches because the screen is small. FIG. 1 shows an exemplary way of selecting an item on a smart watch. FIG. 1(a) shows a user interface 100 for setting the date, consisting of setting the Month 120, setting the day 122, and setting the year 124. In traditional interface design, a user 120 touches one of the selectable elements, for example, the year 124. A new interface 110 appears that displays the list of items 140, 142, 144 to choose from. A user scrolls the list up and down in order to change the displayed items 140, 142, 144, and the user taps on an item 140, 142, 144 displayed on screen to select the item.

This method of selection has a number of drawbacks. First, the display of a new interface 110 often confuses the user, as the user must figure out how to navigate back to the previous screen. Second, scrolling on interface 110 is time consuming. The user must flick her finger many times, each flick involves her finger lifting up from the screen.

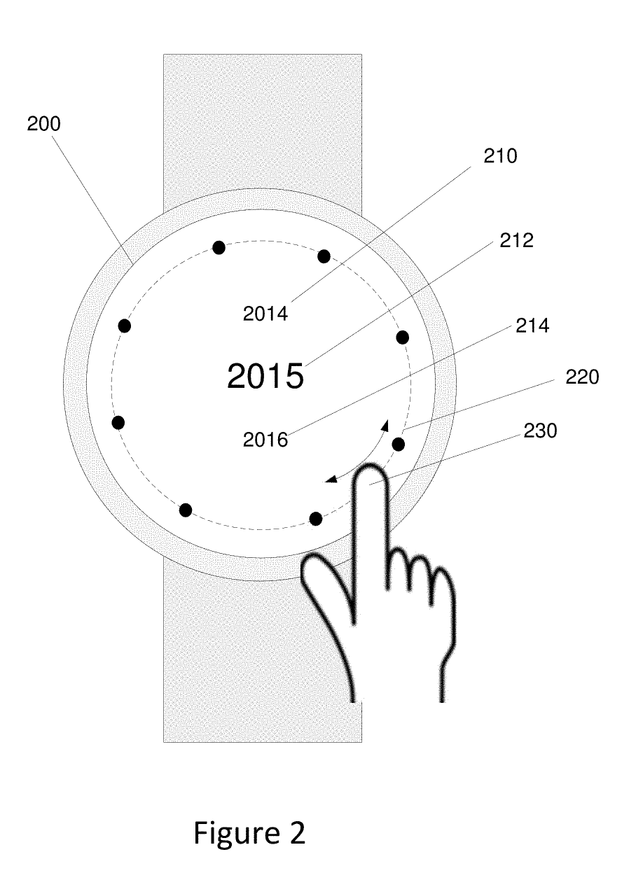

FIG. 2 shows one embodiment of the present invention. When the user touches a selectable element, for example, the year 124, a new selection interface 200 shows up in place. In one embodiment, the original interface 100 is shown underneath interface 200 in dimmed color to give the user a sense that she is still on the same interface screen, but in a selection mode. The new interface 200 shows a list of items 210, 212, 214 to select from, as well as a rotation indicator 220 informing the user that she can rotate on screen to change the displayed items. The user rotates her finger 230 around the screen, and in response to her finger rotation, the displayed items change. One direction of rotation is considered forward rotation, such as when the user rotates clockwise, and the opposite direction is considered backward, for example, when user rotates in the counter-clock direction. When the user rotates forward, the displayed items scroll forward, and when she rotates backward, the displayed items scroll backward. When the user lifts her finger, the item in the center of displayed items is selected, and the selection interface 200 disappears showing the original interface 100 with the updated selected item.

In one embodiment, the displayed subset of items is the complete list of items when they can all fit on screen, and when user rotates her finger, instead of changing the subset of items to be displayed, the visual appearance of the displayed items changes, for example, highlighting one item, to indicate which item will be selected. When the user lifts her finger, the highlighted item is selected.

In one embodiment, the list of items is displayed on a screen, while gesture is detected on a different input device, such as a computer mouse.

In one embodiment, instead of touching to bring up the selection interface, the user must tap the screen to bring up the selection interface. When the user is done with rotate to scroll, she must tap to dismiss the selection interface and select a new item.

In one embodiment, when user rotates forward and the displayed subset of items are at the end of the list of selectable items, a feedback is given to user to indicate that she can not scroll further. Similarly, when the user rotates backward and the displayed subset of items are at the beginning of the list of selectable items, a feedback is given to user to indicate that she can not scroll back further. In one embodiment, the feedback is a visual feedback, where the list tries to scroll, but bounces back to indicate that there are no more items. In another embodiment, the feedback is tactile. The user receives a vibration when she tries to scroll forward beyond the end, or backward beyond the beginning.

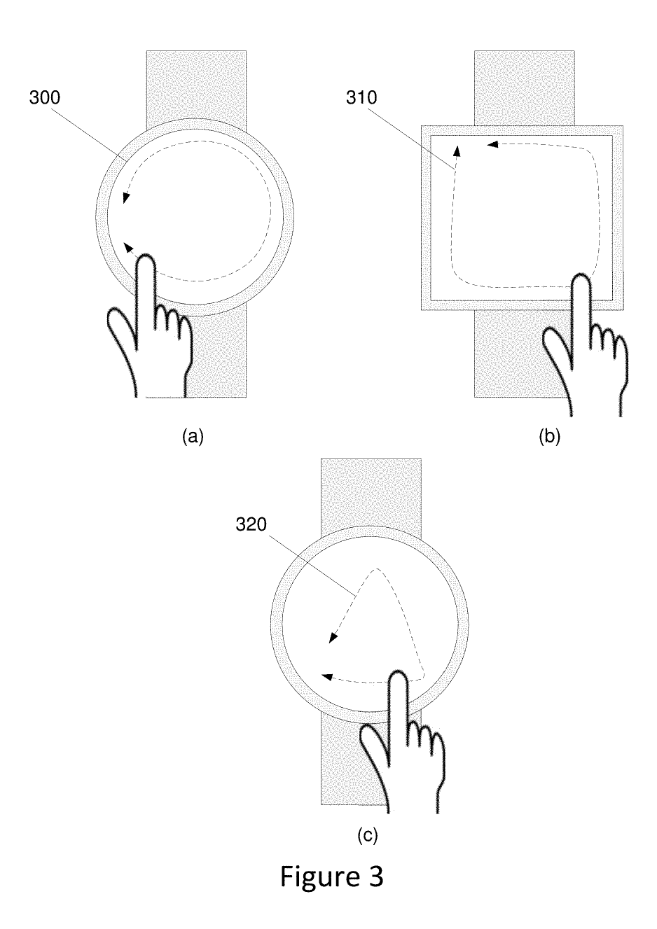

The finger rotating pattern could be any one of a number of patterns. FIG. 3 shows a number of potential patterns. FIG. 3(a) shows a circular pattern the finger can follow back and forth. FIG. 3(b) shows a square pattern, which works well for watches with a square face. FIG. 3(c) shows a triangle pattern. In one embodiment, the rotating pattern the finger follows could be any rotating path that repeats itself, so that the finger can follow the path continuously to keep scrolling the list.

In one embodiment, the rotating gesture is captured in three-dimensional space by a camera or other sensing devices, without the hand touching any physical interface.

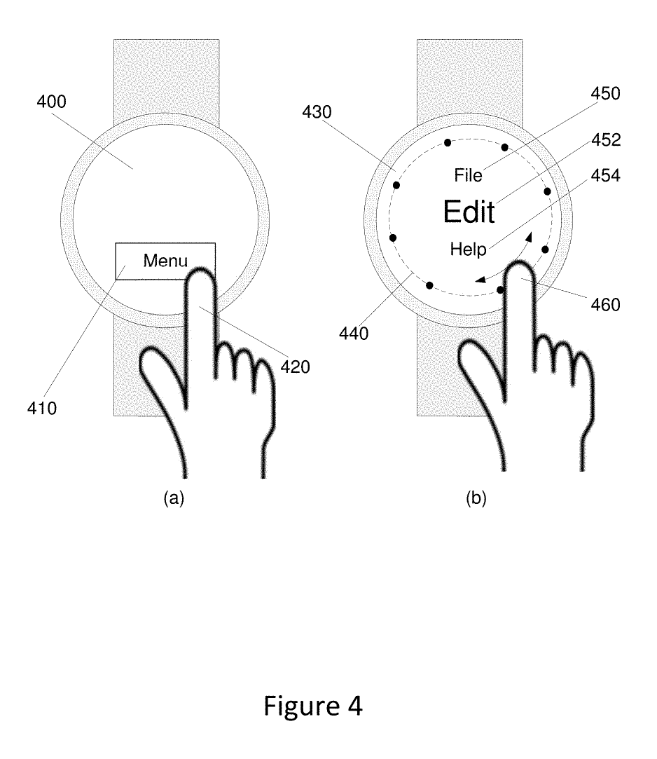

In one embodiment, the rotate gesture could be used to select one of many menu entries. In FIG. 4, an interface 400 shows a menu button 410. When a user places her hand on the menu button, a new selection interface 430 shows up, which consists of a list of menu options 450, 452, 454 and a rotating indicator 440 to inform the user that she can rotate to select items. When the user rotates her hand 460 on screen, the list of items 450, 452, 454 scroll forward or backward to show a different set of items. When the user lifts her hand, the menu option 452 in the center is selected, and the action corresponding to the menu option 452 is invoked.

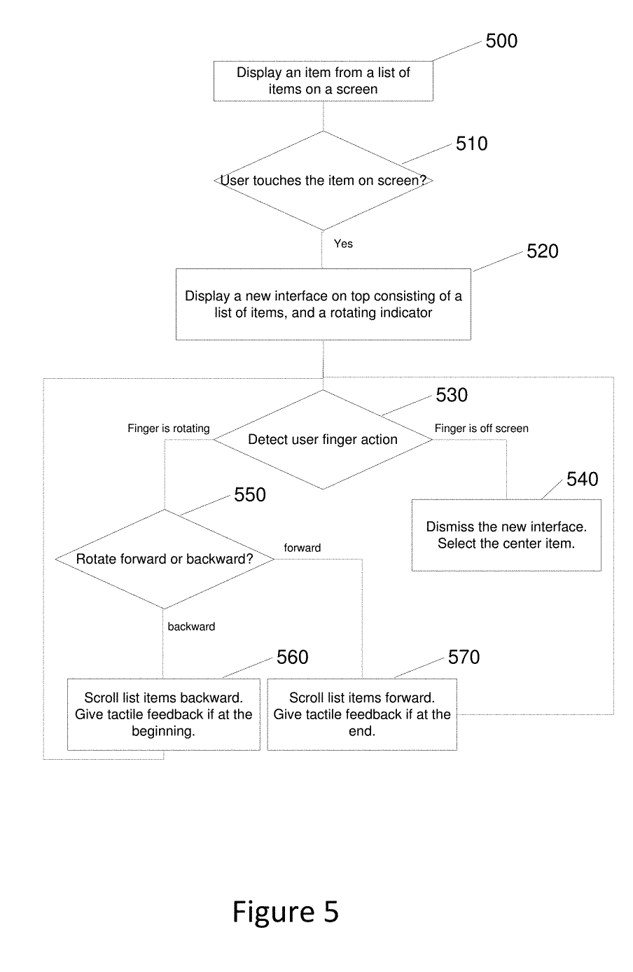

FIG. 5 is a flow diagram of the present invention. In step 500, a user interface is showing a presently selected item. In step 510, user touches the item on screen to indicate she wants to change the selected item. In step 520, a new selection interface is displayed showing the user a subset of a list of items to select from and an indicator telling the user that she can rotate to scroll. Then step 530 looks to interpret the next user input. If the user starts to rotate, the subset of shown items advances in step 570 or backtracks in step 560 depending on whether the user is rotating forward or backward. If the user lifts her finger off screen indicating she is done with selecting, in step 540, the selection interface is dismissed, and the item shown in the center of the selection list is selected.

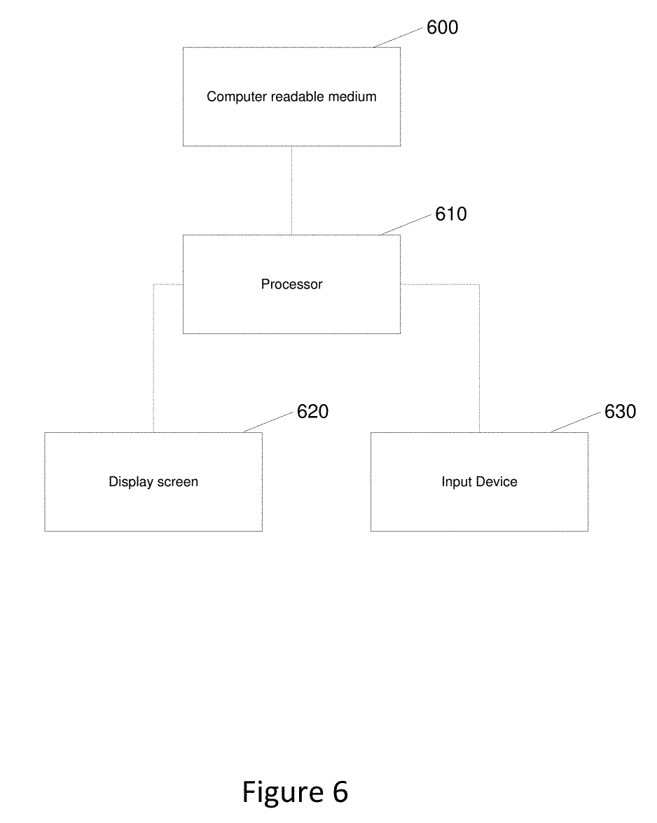

FIG. 6 is a block diagram of an apparatus configured to practice the present invention. A processor 610 reads and executes instructions from a computer readable medium 600, such as a hard disk or flash disk, connected to it. Processor 610 displays a user interface on the display screen 620 and it detects user input from the input device 640. In one embodiment, the input device 640 is a touch device that can interpret human touch. In another embodiment, the input device 640 may be the same physical device as the display device 630, for example, a multi-touch screen.

What is claimed is:

1. A method for providing a user interface, comprising:
a. detecting, using a processor, a first gesture
b. in response to detecting the first gesture, displaying a subset of items from a list of items
c. detecting, using a processor, a second gesture
d. in response to detecting the second gesture, displaying a different subset of items from said list of items
e. detecting, using a processor, a third gesture
f. in response to detecting the third gesture, select an item from the displayed subset of items

2. The method of claim 1, wherein said items are displayed on a touch screen and said first and second gestures are touch gestures performed on the touchscreen.

3. The method of claim 2, wherein said first gesture is touching the screen and said third gesture is releasing touch from the screen

4. The method of claim 3, wherein said second gesture is rotating on the screen

5. The method of claim 4, wherein said different subset of items is the next subset of items from the list when said rotating gesture is moving forward, and said different subset of items is the previous subset of items from the list when said rotating gesture is moving backward

6. The method of claim 5, further comprising:
a. giving feedback to user when said rotating gesture is moving forward and said subset of items are the last set of items in the list, or when said rotating gesture is moving backward and said subset of items are the first set of items

7. The method of claim 6, wherein said feedback is a visual bounce of the displayed items

8. The method of claim 6, wherein said feedback is a tactile feedback

9. An apparatus, comprising:
a. a screen;
b. a processor configured to:
i. detecting a first gesture
ii. displaying a first subset of items from a list of items
iii. detecting a second gesture
iv. displaying a second subset of items from said list of items
v. detecting a third gesture
vi. selecting an item from said second list of items upon detection of the third gesture
